(19) United States
(12) Patent Application Publication
(10) Pub. No.: US 2010/0169700 A1
(43) Pub. Date: Jul. 1, 2010

(54) Adaptive clock enable for memory control

(76) Inventors: Philip Abraham, Hills Boro, OR (US); Steve Kulick, Portland, OR (US); Mahadev Nemani, Hillsboro, OR (US)

Correspondence Address: INTEL CORPORATION;c/o CPA Global, P.O. BOX 52050, MINNEAPOLIS, MN, 55402, US

(21) Appl. No.: 12/317,869

(22) Filed: Dec. 29, 2008

(51) Int. Cl. G06F 1/04

(52) U.S. Cl. 713/600

(57) ABSTRACT

In some embodiments a memory rank idle counter enables de-assertion of a clock enable signal of a rank of a memory for idle systems. Clock enable signal assertion is maintained when there is a lot of traffic to the memory rank. A memory rank idle time prediction counter transfers a value to the memory rank idle counter when the memory rank is idle. Other embodiments are described and claimed.

### TECHNICAL FIELD

The inventions generally relate to adaptive clock enable for memory control.

### BACKGROUND

Computer data storage used by computers to store working data of a computer or other digital electronic devices using one or more bits of data is generally referred to as “memory”. Random Access Memory (RAM) is one form of memory, and Dynamic Random Access Memory (DRAM) is one form RAM. Double-data-rate 3 (DDR3) RAM is a memory technology used for high bandwidth storage of the working data of a computer or other digital electronic devices. RAM is typically implemented in an integrated circuit (IC) form that allows stored data to be accessed. A computer or other electronic device often includes a memory controller used to manage the flow of data going to and from the memory.

A clock enable (CKE) pin of a memory (for example, of a DDR3 DRAM) is used to activate (when high) and deactivate (when low) internal clock signals and devices in the memory. When the CKE signal is low, the chip behaves as if the clock has stopped. No commands are interpreted and command latency times do not elapse. The effect of the CKE signal is delayed by one clock cycle. That is, the current clock cycle proceeds as usual, but the following clock cycle is ignored, except for testing the CKE input signal. Normal operations resume on the rising edge of the clock after the one where the CKE signal is sampled high. That is, all other chip operations are timed relative to the rising edge of the masked clock. The masked clock is the logical AND of the input clock and the state of the CKE signal during the previous rising edge of the input clock. Current implementations tend to use a static counter which waits a specified time after a memory rank goes idle to de-assert the clock enable (CKE) signal.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

### DETAILED DESCRIPTION

Some embodiments of the inventions relate to adaptive clock enable for memory control.

In some embodiments a memory rank idle counter enables de-assertion of a clock enable signal of a rank of a memory for idle systems. Clock enable signal assertion is maintained when there is a lot of traffic to the memory rank. A memory rank idle time prediction counter transfers a value to the memory rank idle counter when the memory rank is idle.

In some embodiments a system includes a memory and a memory controller. The memory controller includes a memory rank idle counter that enables de-assertion of a clock enable signal of a rank of the memory for idle systems. Clock enable signal assertion is maintained when there is a lot of traffic to the memory rank. The memory controller also includes a memory rank idle time prediction counter that transfers a value to the memory rank idle counter when the memory rank is idle.

In some embodiments de-assertion of a clock enable signal of a rank of a memory is enabled for idle systems. An assertion of the clock enable signal is maintained when there is a lot of traffic to the memory rank.

Since a high CKE signal activates and a low CKE deactivates internal clock signals and devices in a memory (for example, in a DRAM and/or a DDR3 DRAM), taking the clock enable (CKE) signal low is useful in reducing memory (for example, DRAM) power. However, there is a performance impact as the memory requires some time to exit power down when the CKE signal transitions from low to high before accepting new commands. Maintaining a minimum performance impact due to this latency requires the CKE signal to always or often be active, whereas minimizing memory power requirements requires the CKE signal to always be de-asserted as soon as the memory rank is idle. Load analysis indicates that the average time to new commands arriving increases with the delay since the last command. Lengthening the delay from rank idle to power down improves performance but reduces power savings.

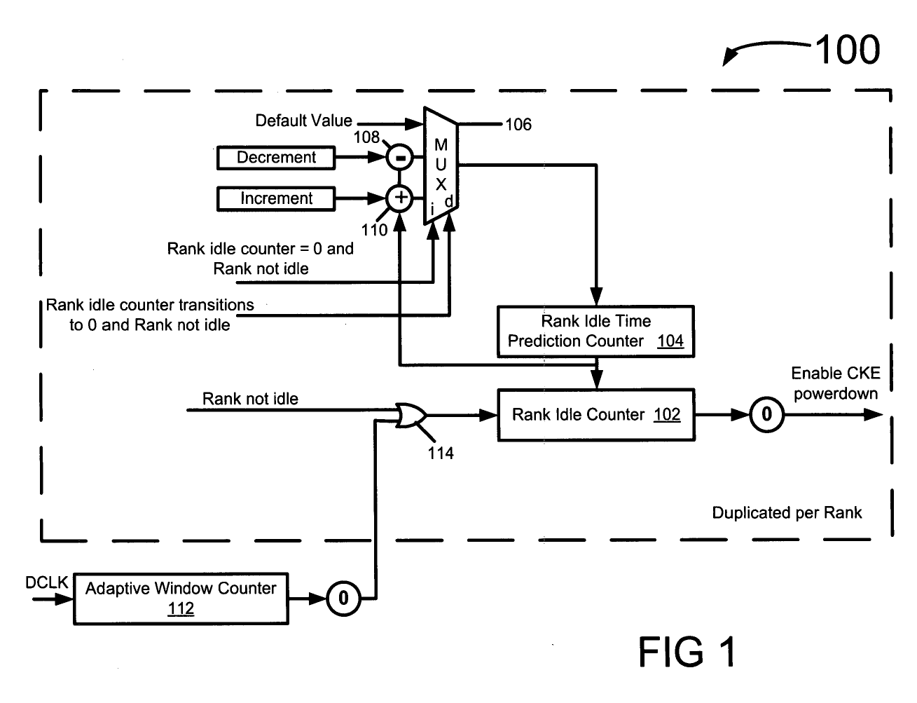

FIG. 1 illustrates a system 100 according to some embodiments. In some embodiments system 100 includes a rank idle counter 102, a rank idle time prediction counter 104, a multiplexer (MUX) 106 with an increment input (select) line i and a decrement input (select) line d, a subtractor 108, an adder 110, an adaptive window counter 112, and an OR gate 114.

In some embodiments system 100 is included in a memory controller that controls a memory (for example, a Random Access Memory or RAM, a Dynamic Random Access Memory or DRAM, a DDR3 DRAM, and/or a DDR3-800 DRAM, etc.) and supplies a clock enable (CKE) signal to the memory. In some embodiments, system 100 is included for each rank in a memory.

In some embodiments, one or more or all of rank idle counter 102, rank idle time prediction counter 104, and/or adaptive window counter 112 are large programmable counters. In some embodiments, one or more or all of rank idle counter 102, rank idle time prediction counter 104, and/or adaptive window counter 112 are 10 bit size counters.

In some embodiments, system 100 provides adaptive clock enable (and/or CKE) control in which the assertion and/or de-assertion of the clock enable signal is adjusted per memory rank by dynamically adjusting the delay between rank idle and power down. This is accomplished, for example, by using past traffic history such that power and performance are optimized. The clock enable assertion and/or de-assertion times are adjusted to take account of traffic patterns to the memory rank.

In some embodiments, per each memory rank there is a rank idle counter 102 and a rank idle time prediction counter 104. The rank idle counter 102 is a decrementing counter that is loaded with an initial value from the rank idle time prediction counter 104 when the associated memory rank is idle (that is, for example, when there are no requests to that memory rank in the memory controller scheduler). When the rank idle counter 102 reaches zero, an enable bit is set to de-assert the clock enable signal (CKE) for that memory rank. The rank idle time prediction counter 104 is, also a decrementing counter, and is loaded with an initial value (default value) from a control register via multiplexer 106. Using multiplexer 106 and/or subtractor 108, the rank idle time prediction counter 104 decrements every time the rank idle counter 102 goes to zero (that is, no new requests have arrived to that memory rank). If a new request arrives to that rank before the rank idle counter 102 goes to zero, then the predicted value is incremented using adder 110 and/or multiplexer 106. The incremented and decremented values can be selected using multiplexer 106, for example. In some embodiments, the increment (i) input to multiplexer 106 selects an increment operation when the rank idle counter is zero and the rank is not idle. In some embodiments, the decrement (d) input to multiplexer 106 selects a decrement operation when the rank idle counter transitions to zero and the rank is idle.

As discussed above, the rank idle prediction counter 104 is a decrementing counter loaded with an initial value (default value) from a control register, for example. The rank idle time prediction counter 104 is saturating and is designed not to overflow. In some embodiments, the clock cycle is DCLK (DDR3 command clock rate, 400 MHz for DDR3-800, for example). In some embodiments, the rank idle time prediction counter 104 also has a minimum floor value. In some embodiments, this minimum floor value is defined by the max(txxxPDEN), for example, where txxxPDEN are a series of timing parameters defined in the DDR3 specification.

In some embodiments, adaptive window counter 112 is shared among all the memory ranks. The value in the rank idle time prediction counter 104 is transferred to the rank idle counter 102 when the adaptive window counter 112 expires. The adaptive window counter 112 is free running and generates a load pulse whenever it transitions to zero. In this manner OR gate 114 is used to help the adaptive window counter 112 update the rank idle counter 102 only when the adaptive window counter 112 expires. This filters out rapid changes to the rank idle time prediction counter 104. After several adaptive window counter 112 intervals the value of the rank idle counter 102 will converge to an optimal value tuned to the memory traffic stream to the memory rank.

In some embodiments, the de-assertion time for the clock enable (CKE) signal is adapted, taking into account traffic patterns to the memory rank (for example, to the DRAM rank). This reduces power by enabling earlier clock enable de-assertion for idle systems, and improves performance by keeping the clock enable signal (and/or CKE signal) asserted when there is a lot of traffic to the memory rank.

In some embodiments, all or part of system 100 is implemented in a memory controller (for example, in a DRAM memory controller) to reduce memory power (for example, DRAM memory power) and minimize impact to performance.

Although some embodiments have been described herein as being related to RAM, DRAM, DDR3, etc., according to some embodiments these particular implementations may not be required, and any implementation relating to any type of memory may be used according to some embodiments.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a memory rank idle counter to enable de-assertion of a clock enable signal of a rank of a memory for idle systems and to keep the clock enable signal asserted when there is a lot of traffic to the memory rank; and
a memory rank idle time prediction counter to transfer a value to the memory rank idle counter when the memory rank is idle.

2. The apparatus of claim 1, further comprising an adaptive window counter, the memory rank idle counter to update only when the adaptive window counter expires.

3. The apparatus of claim 1, wherein the memory rank idle prediction counter to decrement every time no new requests have arrived at the memory rank.

4. The apparatus of claim 1, wherein the apparatus is included in a memory controller.

5. The apparatus of claim 1, wherein the memory rank idle counter is to adjust the assertion and/or the de-assertion of the clock enable signal of the memory rank by dynamically adapting a delay between rank idle and power down using past traffic to the memory rank.

6. The apparatus of claim 1, further comprising for a second rank of the memory:
a memory rank idle counter to enable de-assertion of a clock enable signal of the second rank of the memory for idle systems and to keep the clock enable signal of the second rank of the memory asserted when there is a lot of traffic to the second memory rank; and
a memory rank idle time prediction counter to transfer a value to the memory rank idle counter of the second rank of the memory when the second memory rank is idle.

7. The apparatus of claim 1, further comprising for each rank of the memory:
a memory rank idle counter to enable de-assertion of a clock enable signal of that rank of the memory for idle systems and to keep the clock enable signal of the second rank of the memory asserted when there is a lot of traffic to that memory rank; and
a memory rank idle time prediction counter to transfer a value to the memory rank idle counter of that rank of the memory when that memory rank is idle.

8. A system comprising:
a memory including a clock enable signal of a rank of the memory; and
a memory controller including:
a memory rank idle counter to enable de-assertion of the clock enable signal of a rank of a memory for idle systems and to keep the clock enable signal asserted when there is a lot of traffic to the memory rank; and
a memory rank idle time prediction counter to transfer a value to the memory rank idle counter when the memory rank is idle.

9. The system of claim 8, the memory controller further including an adaptive window counter, the memory rank idle counter to update only when the adaptive window counter expires.

10. The system of claim 8, wherein the memory rank idle prediction counter to decrement every time no new requests have arrived at the memory rank.

11. The system of claim 8, wherein the memory rank idle counter is to adjust the assertion and/or the de-assertion of the clock enable signal of the memory rank by dynamically adapting a delay between rank idle and power down using past traffic to the memory rank.

12. The system of claim 8, the memory controller further including for a second rank of the memory:
a memory rank idle counter to enable de-assertion of a clock enable signal of the second rank of the memory for idle systems and to keep the clock enable signal of the second rank of the memory asserted when there is a lot of traffic to the second memory rank; and
a memory rank idle time prediction counter to transfer a value to the memory rank idle counter of the second rank of the memory when the second memory rank is idle.

13. The system of claim 8, the memory controller further including for each rank of the memory:
a memory rank idle counter to enable de-assertion of a clock enable signal of that rank of the memory for idle systems and to keep the clock enable signal of that rank of the memory asserted when there is a lot of traffic to that memory rank; and
a memory rank idle time prediction counter to transfer a value to the memory rank idle counter of that rank of the memory when that memory rank is idle.

14. A method comprising:
enabling de-assertion of a clock enable signal of a rank of a memory for idle systems; and
keeping the clock enable signal asserted when there is a lot of traffic to the memory rank.

15. The method of claim 14, further comprising adjusting the assertion and/or the de-assertion of the clock enable signal of the memory rank by dynamically adapting a delay between rank idle and power down using past traffic to the memory rank.

16. The method of claim 14, further comprising:
enabling de-assertion of a clock enable signal of a second rank of the memory for idle systems; and
keeping the clock enable signal of the second rank of the memory asserted when there is a lot of traffic to the second memory rank.

17. The method of claim 14, further comprising for each rank of the memory:
enabling de-assertion of a clock enable signal of that rank of the memory for idle systems; and
keeping the clock enable signal of that rank of the memory asserted when there is a lot of traffic to that memory rank.
